(19) United States
(12) Patent Application Publication
(10) Pub. No.: US 2009/0111630 A1
(43) Pub. Date: Apr. 30, 2009

(54) Belt tension adjusting device of vehicle alternator

(75) Inventor: Harumi Kume, Chita-gun (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 12/289,514

(22) Filed: Oct. 29, 2008

(30) Foreign Application Priority Data
Oct. 31, 2007 (JP) 2007-282648

(51) Int. Cl. F16H 7/14

(52) U.S. Cl. 474/133

(57) ABSTRACT

The present invention provides, as one aspect, a belt tension adjusting device of a vehicle alternator. The device comprises an adjust bar that has an elongated hole having a rack configuration, one end of the adjust bar being fixed; a belt tension adjusting gear that has a through-hole at the center thereof, and has a gear-shape member corresponding to the rack configuration of the elongated hole at the outer circumference thereof; and a fixing bolt that fixes the adjust bar and the belt tension adjusting gear with an adjust stay of the vehicle alternator in a state where the belt tension adjusting gear is passed through the elongated hole; wherein tension of a belt stretched around a pulley of the vehicle alternator is adjusted by rotating the belt tension adjusting gear to move the adjust stay in a longitudinal direction of the elongated hole.

### CROSS REFERENCE TO RELATED APPLICATION

This application is based on and claims the benefit of priority from earlier Japanese Patent Application No. 2007-282648 filed Oct. 31, 2007, the description of which is incorporated herein by reference.

### BACKGROUND OF THE INVENTION

1. Technical field of the Invention

The present invention relates to a belt tension adjusting device of a vehicle alternator. The device is used to fix the vehicle alternator to an engine of a vehicle such as a passenger automobile and a motor truck, while the belt is tensioned by the device.

2. Related Art

A vehicle alternator is mounted to a vehicle by connecting a mount stay of the alternator to an engine via a bracket, and by fixing an adjust stay of the alternator to an adjust bar one end of which is connected to the engine. Specifically, the adjust stay is fixed to the adjust bar by a bolt that is inserted in both an elongated hole formed in the adjust stay and a movable member (see, for example, Japanese Unexamined Patent Publication No. 2007-71066). An adjustment of the belt tension is completed by rotating a belt tension adjusting bolt provided at an end portion of the adjust bar, thereby sliding the movable member, which is fixed to the bolt, around the mount stay of the alternator, by the screw pitch. The movable member has a hole for receiving the bolt that fixes the adjust stay, which allows the adjust stay of the vehicle alternator to slide to adjust the belt tension. The position of the adjust stay is fixed by tightening the bolt for fixing the adjust stay, after completion of the adjustment of the belt tension.

The conventional belt tension adjusting device is provided with a belt tension adjustment bolt in the direction in which the belt tension is adjusted and is also provided with a bolt supporting member at the end of the adjust bar. The belt tension adjusting device requires a large installation space, because the device requires space for the adjustment bolt (which moves relative to the adjust bar), in addition to spaces for the adjust bar and the fixing bolt which are used for tensioning the belt. The large space, which is unnecessary after the alternator is mounted on the engine, prohibits the vehicle from becoming compact.

Further, belt tension adjustment by rotating the adjusting bolt requires a space for fitting a tool to the bolt which is rotated to adjust the belt tension, as well as an operation space. This requires a further large space.

Further, since the adjust stay of the vehicle alternator is fixed by the bolt of the movable member of the adjust bar after the belt tension adjustment is completed, a space for fitting a tool to the bolt and an operation space for rotating the bolt are required. Moreover, the bolt for adjusting the belt tension and the bolt for fixing the adjust stay are disposed in different directions which form an angle of 90 degrees, thereby requiring a larger operation space. Such space, which is also needless after the alternator is mounted on the engine, prohibits the vehicle from becoming compact.

### SUMMARY OF THE INVENTION

The present invention has been invented in view of such problems, and it is therefore an object of the present invention to provide a belt tension adjusting device of a vehicle alternator, which minimizes the mounting space of the alternator and the operation space for mounting the alternator.

In order to achieve the object, the present invention provides, as one aspect, a belt tension adjusting device of a vehicle alternator, the vehicle alternator including an adjust stay, a pulley, and a belt stretched around the pulley, comprising: an adjust bar that has an elongated hole having a rack configuration, one end of the adjust bar being fixed; a belt tension adjusting gear that has a through-hole at the center thereof, and has a gear-shape member corresponding to the rack configuration of the elongated hole at the outer circumference thereof; and a fixing bolt that fixes the adjust bar and the belt tension adjusting gear with the adjust stay of the vehicle alternator in a state where the belt tension adjusting gear is passed through the elongated hole; wherein tension of the belt stretched around the pulley of the vehicle alternator is adjusted by rotating the belt tension adjusting gear to move the adjust stay in a longitudinal direction of the elongated hole.

### BRIEF DESCRIPTION OF THE DRAWINGS

In the accompanying drawings:

FIG. 1 is a drawing showing the whole structure of a belt tension adjusting device according to an embodiment; and

FIG. 2 is a sectional view of the belt tension adjusting device according to the embodiment.

### DETAILED DESCRIPTION OF THE PREFERRED EMBODIMENTS

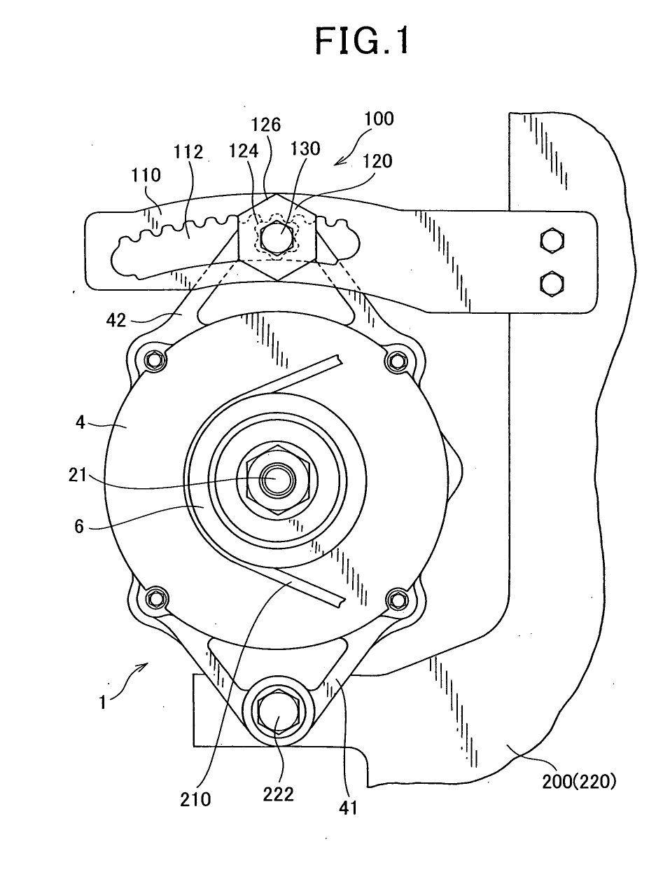

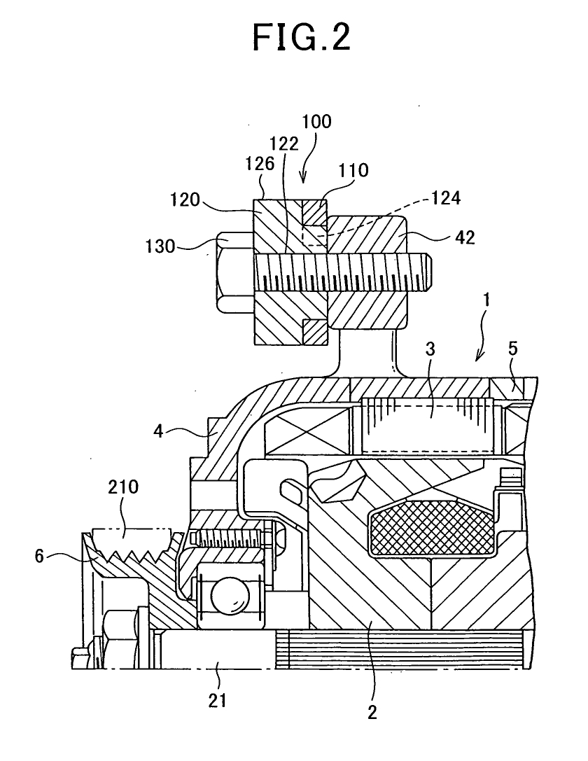

A belt tension adjusting device of a vehicle alternator according to an embodiment of the present invention will be described hereinafter referring to the drawings. FIG. 1 is a drawing showing the whole structure of the belt tension adjusting device according to the embodiment. FIG. 2 is a sectional view of the belt tension adjusting device according to the embodiment.

As shown in FIGS. 1 and 2, a vehicle alternator 1 incorporated with a belt tension adjusting device 100 according to the embodiment comprises a rotor 2, a stator 3, a front-side frame 4, a rear-side frame 5, a pulley 6, and the like. The pulley 6 is tightly fixed to the end portion of a rotation axis 21 of the rotor 2. The rotation of the pulley 6 by an engine 200 via a belt 210 causes the rotor 2 to rotate together with the pulley 6.

The front-side frame 4 disposed at the side of the pulley 6 is provided with a mount stay 41 and an adjust stay 42, which project from the periphery of the front-side frame 4. The mount stay 41 is fixed to an engine bracket 220, which is a part of the engine 200, by a fixing bolt 222. The adjust stay 42 is fixed to an adjust bar (adjustment bar) 110, one end of which is fixed to the engine bracket 220, by a fixing bolt 130.

Next, the belt tension adjusting device 100 according to the embodiment will be described in detail. As shown in FIGS. 1 and 2, the belt tension adjusting device 100 includes an adjust bar 110, a belt tension adjusting gear 120, and a fixing bolt 130. The adjust bar 110 has a plate-like configuration and one end thereof is fixed to the engine bracket 220. An elongated hole 112 having a rack configuration is formed in the longitudinal direction in the approximately center of the adjust bar 110. The rack configuration is formed at one of the two opposing sides of the elongated hole 112. This one side of the elongated hole 112 is formed along an arc. The distance between the arc and a mounting through-hole formed in the mount stay 41 is constant. The rack configuration is formed along the one side of the elongated hole 112. The rack configuration may be formed at both of the two opposing sides of the elongated hole 112.

The belt tension adjusting gear 120 has a through-hole 122 at the center thereof, and has a gear-shape member 124 to be engaged with the rack configuration of the elongated hole 112 and a polygonal-shape member 126 at the outer circumference thereof. The thickness of the gear-shape member 124 in the axis direction is smaller than the thickness of the adjust bar 110 (for the sake of simplicity, FIG. 2 shows the thickness of the gear-shape member 124 in the axis direction to be equal to the thickness of the adjust bar 110).

The polygonal-shape member 126 may be a hexagon, for example. The diameter of the polygonal-shape member 126 is larger than the width of the elongated hole 112.

The fixing bolt 130 is used to fix the adjust bar 110 and the belt tension adjusting gear 120 to the adjust stay 42 of the vehicle alternator 1, while the belt tension adjusting gear 120 is passed through the elongated hole 112.

Next, a process of mounting the vehicle alternator 1 to the engine bracket 220 while the belt is tensioned using the belt tension adjusting device 100 of the embodiment will be described.

1. The vehicle alternator 1 is temporarily fixed to the engine bracket 220 using the fixing bolt 222 that passes through the mounting lo through-hole formed in the mount stay 41. The fixing bolt 222 in this stage is not tightly screwed. Then, the belt 210 is stretched around (and engaged with) the pulley 6.

2. The fixing bolt 130 penetrating the belt tension adjusting gear 120 is screwed into a screw hole of the adjust stay 42, while the gear-shape member 124 of the belt tension adjusting gear 120 is engaged with the rack configuration of the elongated hole 112 of the adjust bar 110. In this stage, the fixing bolt 130 is screwed so that the belt tension adjusting gear 120 is allowed to rotate.

3. A tool is fitted to the polygonal-shape member 126 of the belt tension adjusting gear 120. The polygonal-shape member 126 is rotated using the tool to rotate the whole belt tension adjusting gear 120. The engagement between the gear-shape member 124 and the rack configuration portion of the adjust bar 110 allows the gear 120 to slide in the longitudinal direction of the elongated hole 112. The slide movement of the belt tension adjusting gear 120 through which the fixing bolt 130 penetrates allows the adjust stay 42 to slide together with the gear 120 in the longitudinal direction of the elongated hole 112, thereby adjusting the tension of the belt 210. After the tension of the belt 210 is adjusted, the fixing bolt 130 is tightly fixed by the tool, which secures the adjust stay 42 and the adjust bar 110 with each other.

The belt tension adjusting device 100 of the embodiment can adjust the tension of the belt 210 by rotating the belt tension adjusting gear 120 to change its position relative to the elongated hole 112 of the adjust bar 110 having the rack configuration. The device 100 does not require such a long adjusting bolt that is disposed in the direction in which the adjust stay 42 moves to adjust the position of the adjust stay 42. This allows the device 100 not to require a space for disposing the adjusting bolt, nor operation space for rotating the adjusting bolt, which minimizes a mounting space of the vehicle alternator 1 and an operation space for mounting the alternator 1. Further, the rotation axis of the belt tension adjusting gear 120 and the rotation axis of the fixing bolt 130 for fixing the adjust stay 42 are agreed with each other, which allows the device 100 not to require an operation space for rotating the belt tension adjusting gear 120 and an operation space for rotating the fixing bolt 130, individually. This can further minimize the operation space.

Further, at least one of the two sides of the elongated hole 112 is formed along an arc. The distance between the arc and a mounting through-hole formed in the mount stay 41 is constant. The rack configuration is formed along the at least one of the two sides of the elongated hole 112. Accordingly, the rotation of the belt tension adjusting gear 120 can change the mounting angle of the vehicle alternator 1 around the mounting through-hole formed in the mount stay 41, resulting in an accurate adjustment of the tension of the belt 210 stretched around the pulley 6.

While the present invention has been disclosed in terms of the preferred embodiment in order to facilitate better understanding thereof, it should be appreciated that the invention can be embodied in various ways without departing from the principle of the invention. For example, although FIG. 1 shows the mount stay 41 and the adjust stay 42 which are disposed around the rotation axis 21 at an angle of about 180 degrees (that is, the mount stay 41 and the adjust stay 42 are disposed at the opposite positions with respect to the rotation axis 21), the mount stay 41 and the adjust stay 42 may be disposed around the rotation axis 21 at an angle of other than 180 degrees.

It will be appreciated that the present invention is not limited to the configurations described above, but any and all modifications, variations or equivalents, which may occur to those who are skilled in the art, should be considered to fall within the scope of the present invention.

What is claimed is:

1. A belt tension adjusting device of a vehicle alternator, the vehicle alternator including an adjust stay, a pulley, and a belt stretched around the pulley, comprising:
an adjust bar that has an elongated hole having a rack configuration, one end of the adjust bar being fixed;
a belt tension adjusting gear that has a through-hole at the center thereof, and has a gear-shape member corresponding to the rack configuration of the elongated hole at the outer circumference thereof; and
a fixing bolt that fixes the adjust bar and the belt tension adjusting gear with the adjust stay of the vehicle alternator in a state where the belt tension adjusting gear is passed through the elongated hole; wherein
tension of the belt stretched around the pulley of the vehicle alternator is adjusted by rotating the belt tension adjusting gear to move the adjust stay in a longitudinal direction of the elongated hole.

2. The device according to claim 1, wherein
the belt tension adjusting gear has a polygonal-shape member at the outer circumference thereof, and
tension of the belt stretched around the pulley of the vehicle alternator is adjusted by rotating the polygonal-shape member.

3. The device according to claim 1, wherein
the vehicle alternator includes a mount stay having a mounting through-hole,
the elongated hole has sides, at least one of the sides being formed along an arc, and the distance between the arc and the mounting through-hole of the mount stay being constant, and
the rack configuration is formed along the at least one of the sides.

4. The device according to claim 3, wherein
the vehicle alternator includes a rotor, and
the mount stay and the adjust stay are disposed at opposite positions with respect to a rotation axis of the rotor.
